(19) United States
(12) Patent Application Publication
(10) Pub. No.: US 2008/0170567 A1
(43) Pub. Date: Jul. 17, 2008

(54) PACKET SWITCH APPARATUS AND METHOD THEREOF

(76) Inventor: Min-Kyu JOO, Suwon-si (KR)

Correspondence Address: CHA & REITER, LLC, 210 ROUTE 4 EAST STE 103, PARAMUS, NJ, 07652, US

(21) Appl. No.: 12/014,171

(22) Filed: Jan. 15, 2008

(30) Foreign Application Priority Data
Jan. 16, 2007 (KR) 4763/2007

(51) Int. Cl. H04L 12/56

(52) U.S. Cl. 370/389

(57) ABSTRACT

Disclosed is a packet switch apparatus applied to Internet Protocol (IP) network, the packet switch apparatus including: an Ethernet switch to perform packet switching, the Ethernet switch including a plurality of ports and a layer 3 table. The plurality of ports include a dummy port, which has an available port number allowing hardware-access, discards packets switched to the dummy port, and exists as a logical number, the layer 3 table storing Media Access Control (MAC) addresses corresponding to IP addresses of hosts and information about corresponding connection ports. A controller determines the nonexistence of the MAC address, virtually sets the MAC address corresponding to the destination IPv6 address, and updates the layer 3 table of the Ethernet switch chip as if the host of the set virtual MAC address were connected to the dummy port, when the MAC address corresponding to destination IPv6 address of the packet trapped by the Ethernet switch chip does not exist.

### CLAIM OF PRIORITY

This application claims the benefit under 35 U.S.C. §119(a) of an application entitled “Packet Switch Apparatus and Method Thereof,” filed in the Korean Intellectual Property Office on Jan. 16, 2007 and assigned Serial No. 2007-4763, the contents of which are hereby incorporated by reference.

### BACKGROUND OF THE INVENTION

1. Field of the Invention

The present invention relates to a packet switch apparatus of a packet-based network, such as an Ethernet. More particularly the present invention relates to a packet switch apparatus and a method thereof providing a 2/3-layer switching function on the basis of an Ethernet switch chip.

2. Description of the Related Art

In general, to use a 3-layer IP routing function in a 2/3-layer switching apparatus, based on the Ethernet switch chip, a Media Access Control (MAC) address and IP addresses of both source host and destination host are indispensable. Herein, when Internet Protocol version 6 (IPv6) is used as a 3-layer protocol, an apparatus for driving a switch chip must acquire the information about MAC address corresponding to an IP address of each host. The “Neighbor Discovery” mechanism in IETF RFC 2461 (Neighbor Discovery for IP Version 6) standard defines a procedure of obtaining the MAC address mapped to the IP address. The protocol messages in “Neighbor Discovery” are also defined as standards in RFC 2463 ICMPv6 (Internet Message Protocol for the Internet Protocol Version 6 Specification). In order to perform IP Routing in an IPv6 network, a procedure of acquiring the MAC address of a Link layer through the procedure defined in RFC 2461 “Neighbor Discover” mentioned above is needed.

FIG. 1 is a schematic block diagram illustrating a conventional packet switch apparatus (e.g., an Ethernet switch). Additionally, FIG. 1 shows a conventional procedure of acquiring a MAC address corresponding to an IP address according to a Neighbor Discovery Protocol (NDP). Referring to FIG. 1, first, a conventional packet switch apparatus 10 includes an Ethernet switch chip 12, which has a plurality of ports (e.g., 8 ports). A plurality of subscriber terminals (a Host A, a Host B, etc.) may be connected to each of the ports. The conventional packet switch apparatus 10 further includes a CPU 11 for controlling a packet which passes through the Ethernet switch chip 12 and operation related to control of ports.

A packet switch method will be described with reference to an example of transferring packets from the Host A to the Host B (i.e., a destination) in the packet switch apparatus 10.

Step (1): Host A can obtain the MAC address information and the IP address of its own default gateway (in case of FIG. 1, an Ethernet switch apparatus 10) by using a “Router Advertisement” message that the Ethernet switch apparatus 10 periodically transfers. When the “Router Advertisement” message is not transferred to the Host A, Host A creates a “Router Solicitation” message and causes the switching apparatus to retransmit the “Router Advertisement” message. When the Host A directly sets the IP address of the default gateway and does not acquire MAC address of the corresponding gateway, the Host A creates a “Neighbor Solicitation” message. Then the gateway sends a “Neighbor Advertisement” message as a response for the “Neighbor Solicitation” message. Through this process, the gateway obtains the IP address of the Host A and the MAC address corresponding to the gateway.

Step (2): Host A has acquired the MAC address of the gateway (i.e. Ethernet switch apparatus 10) through step mentioned above. Host A then transmits a packet, which has the Host B as a destination IP, to the gateway. For example, the transmitted packet may have a format as follows.

| | |
|---|---|
| Destination MAC = 00:00:00:00:00:01 | Source MAC = |
| | 00:00:00:00:00:02 |
| Destination IP = 3ffe:200::2 | Source IP = 3ffe:100::2 |

Step (3): When a packet transmitted from the Host A and destined to the Host B is transferred to an Ethernet switch chip 13, the Ethernet switch chip 13 determines if its own layer 3 table (not shown) includes the destination IP address of the packet transferred by switching mechanism of the Ethernet switch chip 13. If the layer 3 table does not include the corresponding destination IP address, the Ethernet switch chip 13 causes the corresponding packet to be trapped by the CPU 11 in order to perform a process (“Address resolution”) of discovering the MAC address of the Host B.

Meanwhile, if the layer 3 table includes the corresponding destination IP address of the transferred packet, the Ethernet switch chip 13 directly switches the corresponding packet to the port where the Host B is connected. In this case, it is possible to perform routing of the corresponding packet by only the hardware switching function of the Ethernet switch chip 12 irrespective of the CPU 11.

Step (4): The packet trapped on the CPU 11 acquires the MAC address of the destination IP address through the following procedure according to the operation program of the CPU 11.
Is the destination IP address of the trapped packet included in the subnet of the CPU?
When the destination IP address of the trapped packet is included in its own subnet, is the CPU 11 aware of the MAC address of the corresponding IP address?
When both the destination IP address of the trapped packet is included in the subnet of the CPU 11 and the CPU 11 is not aware of the MAC address, the CPU 11 transmits a “Neighbor Solicitation” message in order to discover the MAC address of the corresponding IP address.

Step (5): The CPU 11 transmits the “Neighbor Solicitation” message in order to find out the MAC address of the Host B. If the Host B exists, then the Host B transmits the “Neighbor Advertisement” message as a response for the “Neighbor Solicitation” message. If the Host B does not exist, the CPU 11 periodically transmits the “Neighbor Solicitation” message until the CPU 11 discovers the MAC address of the Host B.

Step (6): After receiving the “Neighbor Advertisement” message from the Host B, the CPU 11 updates the IP address of the Host B and MAC address of the Host B on the layer 3 table of the Ethernet switch chip 12.

Step (7): After the layer 3 information about the Host B is updated on the Ethernet switch chip 12, the Ethernet switch chip 12 switches a packet to be transferred from the Host A to the Host B by hardware irrespective of operation of the CPU 11.

As described above, in order to perform switching using the layer 3 table of the Ethernet switch chip, the IP address information and the MAC address information of a destination host, (i.e. items necessary for the layer 3 table of the Ethernet switch chip) must be updated by the CPU. When a packet destined to an IP address, which is not included in the layer 3 table, is input, the Ethernet switch chip traps all of corresponding packets on the CPU in order to update the IP address information and the MAC address information of the destination host. The scheme mentioned above has a number limitations, including the following.

1) For example, when the Host A keeps on transmitting a packet to be transmitted to the Host B, a packet trap by the Ethernet switch chip continues until the corresponding layer 3 table is updated. This eventually causes a CPU trap without a break, such that the CPU may be overloaded due to the trapped packets. The CPU overload may have an influence on other tasks which should be performed by the CPU.

The higher the bandwidth of the Ethernet switch chip is the more serious the influence may be.

2) When a packet destined to an IP address, which is not included in the layer 3 table, is continually input, the “Address resolution (Neighbor Solicitation)” process by the CPU will continue, thereby causing waste of the CPU and network bandwidth.

3) While the process of updating the layer 3 table by using the “Neighbor Solicitation/Neighbor Advertisement” message generally has a priority over other packets owing to the problems mentioned above. However, when a packet destined to a nonexistent IP hand is maliciously input, the CPU continually creates a large number of “Neighbor Solicitation” messages. This may cause waste in the CPU and network bandwidth and may serve as a vulnerability in network security.

In order to drive the “Neighbor Solicitation/Neighbor Advertisement” mechanism by the CPU, it is enough to trap only one packet on the CPU for each corresponding IP address. However, because such a function is not supported by the Ethernet switch chip, there is a need for a method for generating the CPU trap with as few packets as possible.

### SUMMARY OF THE INVENTION

Accordingly, the present invention has been made to solve the above-mentioned problems occurring in the prior art. The present invention provides a method for reducing the load of the CPU and driving “Neighbor Discover” mechanism by trapping as few packets as possible on the CPU among packets input before update of the layer 3 table of the Ethernet switch chip is completed. The present invention further provides a method for preventing continuous transmission of “Neighbor Solicitation” message for a nonexistent host.

In accordance with an aspect of the present invention, there is provided a packet switch apparatus applied to a network, the packet switch apparatus including: a switch to perform packet switching including a plurality of ports and a table, the plurality of ports including a dummy port, which has an available port number allowing hardware-access, discards packets switched to the dummy port, and exists as a logical number, the table storing addresses corresponding to network addresses of hosts and information about corresponding connection ports, and a controller to, when the address corresponding to destination network address of the packet trapped by the Ethernet switch chip does not exist, determine the nonexistence of the address, virtually set the address corresponding to the destination network address, and update the table of the switch chip as if the host of the set virtual address were connected to the dummy port.

In accordance with another aspect of the present invention, there is provided A packet switching method of the packet switching apparatus applied to the a network, the packet switching apparatus including a switch to perform packet switching, which includes a table storing address corresponding to the network address of the hosts and information about the corresponding connection port, the method including the steps of: virtually setting, when information about address corresponding to the network address of the destination host of the packet transmitted from a certain host is not prestored, the address corresponding to the destination network address, and updating the layer 3 table of the switch chip as if the host of the set virtual address were connected to the preset virtual dummy port; and updating the table of the switch by transmitting the “Neighbor Solicitation” message and receiving a response for the “Neighbor Solicitation” message in order to identify the address corresponding to the actual network address of the corresponding destination.

### BRIEF DESCRIPTION OF THE DRAWINGS

The present invention will be more apparent from the following detailed description taken in conjunction with the accompanying drawings, in which:

FIG. 1 is an schematic block diagram illustrating a conventional packet switch apparatus;

FIG. 2 is an schematic block diagram illustrating a packet switch apparatus according to an embodiment of the present invention; and

FIGS. 3A and 3B are a flowchart illustrating a packet switch operation according to an embodiment of the present invention.

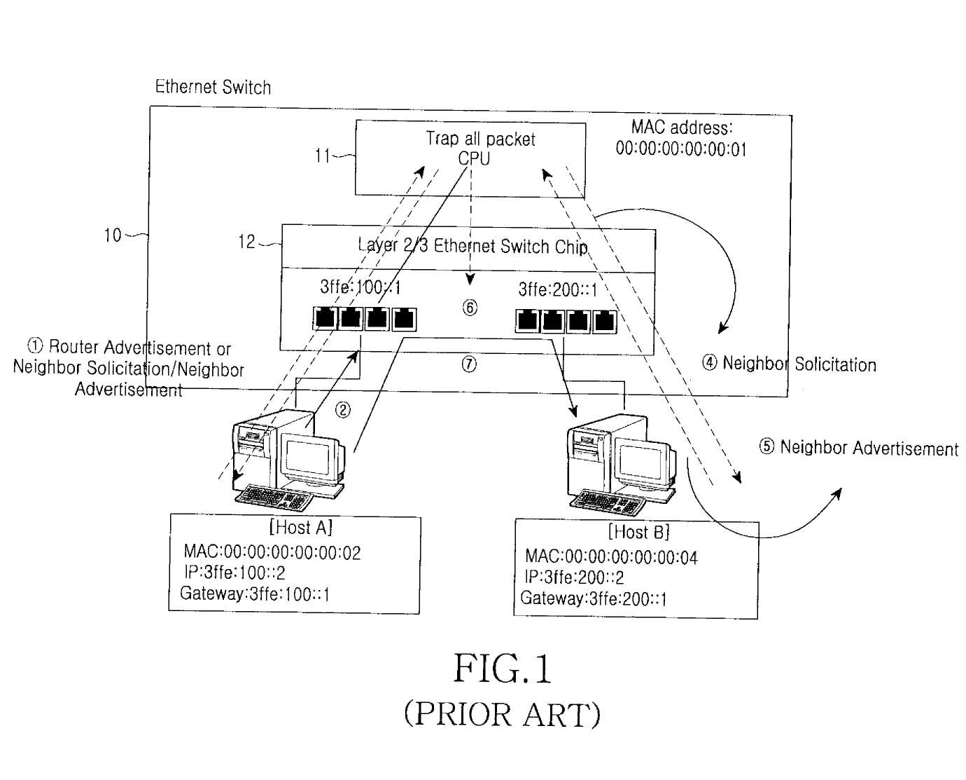

### DETAILED DESCRIPTION OF THE INVENTION

Hereinafter, an exemplary embodiment according to the present invention will be described with reference to the accompanying drawings. In the below description, many particular items such as a detailed component apparatus are shown, but these are given only for providing the general understanding of the present invention, it will be understood by those skilled in the art that the present invention can be embodied without including these particular items.

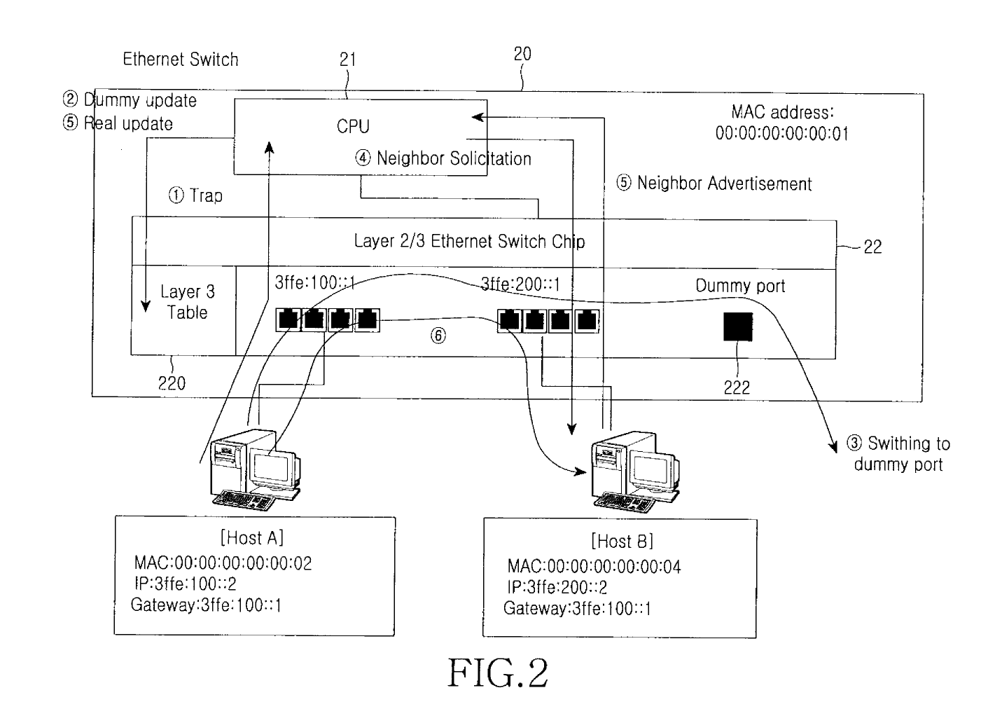

FIG. 2 is a schematic block diagram illustrating a packet switch apparatus according to an embodiment of the present invention. Additionally, FIG. 2 shows a procedure of acquiring a MAC address corresponding to network address, such as Internet Protocol version 6 (IPv6) (hereinafter, abbreviated as ‘IP address’) according to Neighbor Discovery Protocol (NDP) in a packet switch apparatus of the present invention. Referring to FIG. 2, similarly to the conventional packet switch apparatus, a packet switch apparatus 20 according to the present invention includes an Ethernet switch chip 22 which has a plurality of ports. Each of the various subscriber terminals (a Host A, a Host B, etc.) may be connected to each port. The conventional packet switch apparatus 10 further includes a CPU 21 for controlling a packet which passes through the Ethernet switch chip 22 and operation related to control of ports.

In the configuration above, the Ethernet switch chip 22 includes a virtual dummy port 222a. The dummy port 222a, however, is not a physical port. The dummy port 222a exists as a logical number within the Ethernet switch chip. Although the dummy port 222a has an available port number allowing hardware-access, when packets are switched to the dummy port 222a, all of the packets are discarded, then a packet cannot be input through the dummy port 222a.

When there is no MAC address corresponding to the destination IP address of the trapped packet from the Ethernet switch chip 22, according to the features of the present invention, the CPU 21 of the packet switch apparatus 20 virtually sets the MAC address corresponding to the destination host IP address, and updates the layer 3 table 220 of the Ethernet switch chip 22 as if the host of the set virtual MAC address were connected to the dummy port 222a.

Also, the CPU 21 transmits “Neighbor Solicitation” message in order to identify the MAC address corresponding to the actual address of the destination IP and a port where the destination host is connected. When the CPU 21 receives a response for the “Neighbor Solicitation” message above, it updates the set virtual MAC address and dummy port information on the layer 3 table 220 to actual information according to the response above. As mentioned above, after dummy port information is deleted and updated to response information, the corresponding packet is normally switched.

Illustratively, the packet switch method according to the present invention will be described in more detail with reference to an exemplary case where a packet is transferred from the Host A to the destination Host B in a packet switch apparatus having the configuration mentioned above as illustrated in FIG. 2.

Step (1): When a packet to be transferred from a specific host (e.g. Host A of FIG. 2) to an another host (e.g. Host B of FIG. 2) which exists in the same subnet is input, the Ethernet switch chip 22 transfers the corresponding packet to the CPU 21 unless layer 3 table of the Ethernet switch chip 22 includes an item corresponding to the destination IP address.

Step (2): After the CPU 21 identifies that there is no MAC address corresponding to the destination IP address of the transferred packet from the Ethernet switch chip 22, the CPU 21 first virtually sets the MAC address corresponding to the destination IP address and updates the layer 3 table 220 of the Ethernet switch chip 22 as if the corresponding host were connected to the dummy port 222a.

Step (3): When the item designated as the dummy port 222a is updated on the layer 3 table 220 of the Ethernet switch chip 22, the same destination IP address input after completing the update is switched to the dummy port 222a and the corresponding packet is not trapped on the CPU 21 any more.

Step (4) Thereafter, the CPU 21 transmits the “Neighbor Solicitation” message in order to identify that the MAC address corresponding to the actual address of the destination IP and a port where the destination host is connected. In this case, the CPU 21 also transmits the “Neighbor Solicitation” message up to X times, i.e., a predetermined maximum number of times for trial in preparation for no reception of the “Neighbor Advertisement” message as a response for the “Neighbor Solicitation” message.

Step (5): When the response for the “Neighbor Solicitation” message of the CPU 21 is received within the maximum number of times for trial, the CPU 21 deletes the virtually set MAC address information and dummy port information of Step (2) from the layer 3 table 220 and updates the layer 3 table 220 by the newly received actual information (MAC address and port information).

Step (7): When deletion of the dummy port information has been completed through the operation of Step (5) above and the layer 3 table has been updated to the received information, the corresponding packet is normally switched by the Ethernet switch chip.

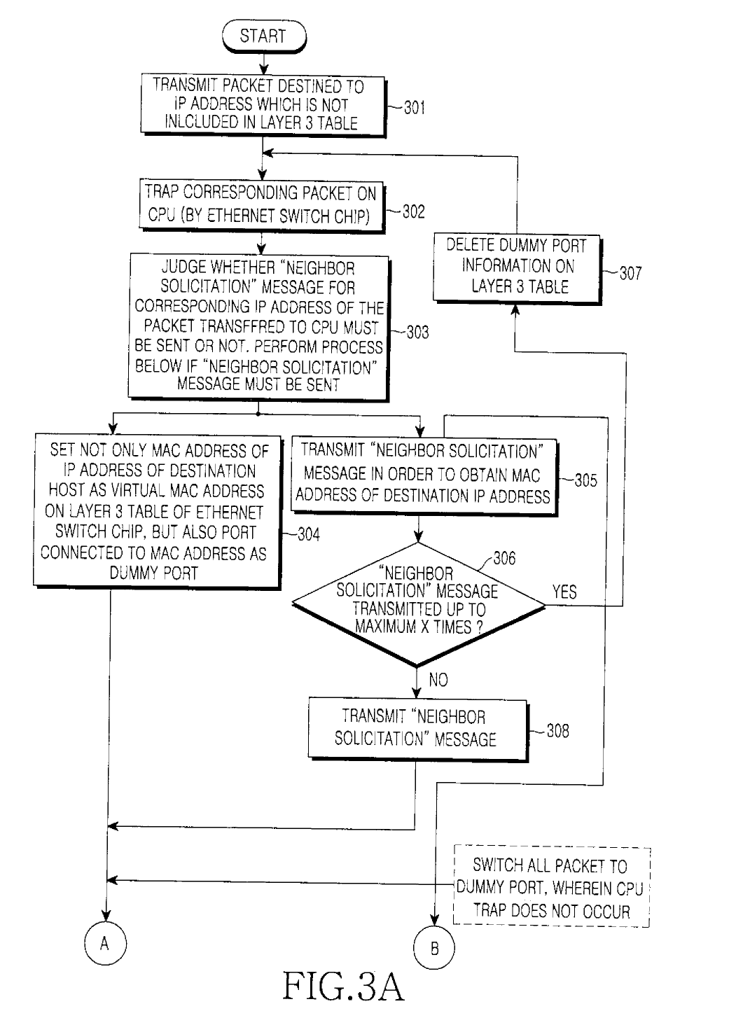

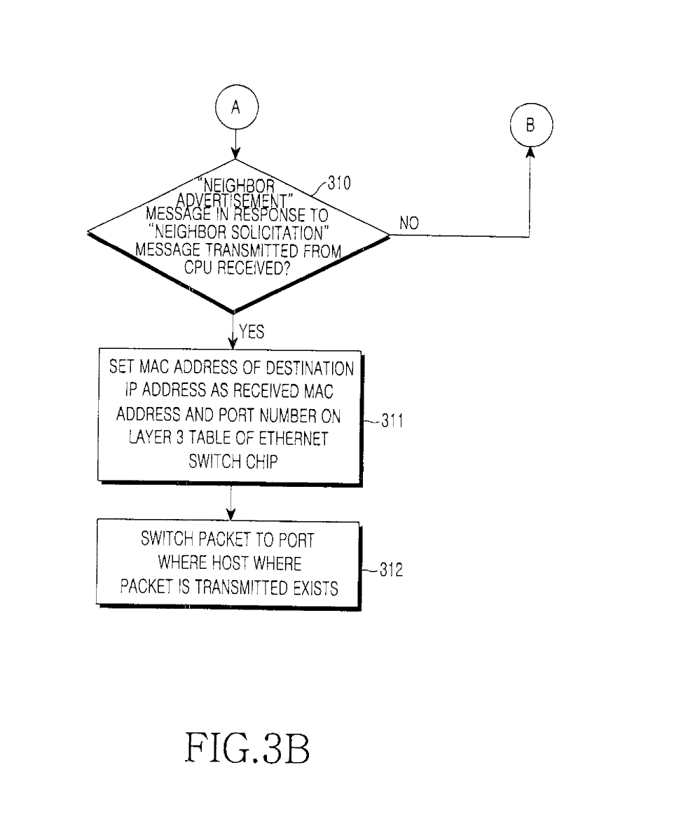

Meanwhile, if the CPU 21 does not receive the response for the “Neighbor Solicitation” message within the maximum number of times for trial, the CPU 21 deletes virtually set MAC address information and dummy port information of Step (2). After completing the deletion, the Ethernet switch chip 22 generates the CPU trap again, and the procedure subsequent to Step (2) mentioned above is repeated. Hereinafter, a method for packet processing, which corresponds to the operation of the packet switch apparatus according to the present invention, will be described in more detail step by step with reference to FIGS. 3A and 3B.

FIGS. 3A and 3B are a flowchart illustrating a packet switch operation according to an exemplary embodiment of the present invention. First, when a packet, which is to be transmitted from a certain host to a destination host in the same subnet, is received, the Ethernet switch chip included in the packet switch apparatus identifies if the layer 3 table of the Ethernet switch chip includes information of MAC address corresponding to the IP address of the destination host and port information. When a packet destined to an IP address, which is not included in the layer 3 table, is transmitted from a certain host, the Ethernet switch chip traps the received packet on the CPU (step 301, 302).

Then, in step 303, the CPU determines whether or not it is necessary to send the “Neighbor Solicitation” message for the IP address of the destination host where the received packet trapped from the Ethernet switch chip has been transferred. In step 303, the CPU identifies whether the layer 3 table includes port information and MAC address information for the IP address of the destination host. If the layer 3 table does not include port information and MAC address information for the IP address of the destination host, the CPU decides that “Neighbor Solicitation” message must be sent in order to obtain the port information and MAC address of the destination host.

Thereafter, steps 304 and 305 are performed. In step 304, the CPU sets the MAC address corresponding to the IP address of the destination host as a virtual MAC address on the layer 3 table of the Internet switch chip, also sets the port connected to the MAC address as a dummy port, and then proceeds to step 310.

In step 305, the CPU transmits the “Neighbor Solicitation” message in order to obtain the MAC address of the destination IP address. Herein, while the “Neighbor Solicitation” message is repeatedly transmitted from the CPU to the destination host at a predetermined frequency corresponding to the maximum number of times for trial until the destination host transmits the response for the “Neighbor Solicitation” message. The CPU determines whether the “Neighbor Solicitation” message has been transmitted up to the maximum number of times for trial (step 306). If the “Neighbor Solicitation” message has been transmitted up to the maximum number of times for trial, the CPU proceeds to step 307. In step 307, the CPU deletes the virtual MAC address of the destination host and dummy port information, which have been set on the layer 3 table, and proceeds to step 302. Then, the CPU repeatedly performs the procedures mentioned above. Meanwhile, when the CPU has not transmitted the “Neighbor Solicitation” message up to the maximum number of times for trial as a result of the determination of step 306, the CPU proceeds to step 308. In step 308, the CPU retransmits the “Neighbor Solicitation” message, and then proceeds to step 310. Because the packet, which is received from the source host during performing the process, is switched to the dummy port set on layer 3 table, the CPU trap does not occur.

In step 310, the CPU determines whether the CPU receives the “Neighbor Advertisement” message as a response for the “Neighbor Solicitation” message transmitted from the CPU. If the “Neighbor Advertisement” message has not been transmitted to the CPU as a result of the determination, the CPU returns to step 305 and repeatedly performs the operation above. If the “Neighbor Advertisement” message has been transmitted to the CPU, the CPU proceeds to step 311.

In step 311, the CPU sets the MAC address of the destination IP address as the received MAC address and a port number on the layer 3 table of the Ethernet switch chip. Thereafter, the corresponding packet is switched to the port where the host to which the packet is transmitted exists (step 312).

As described above, it is possible to reduce the load of the CPU and drive the “Neighbor Discovery” mechanism. This is accomplished using the packet switch apparatus and the packet switching method according to the present invention to trap as few packets as possible on the CPU among received packets before an update of the layer 3 table of the Ethernet switch chip is completed. Also, the packet switch apparatus and the packet switching method according to the present invention can be used to prevent from infinitely transmitting the “Neighbor Solicitation” message for a nonexistent host.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A packet switch apparatus applied to a network, comprising:
a switch to perform packet switching, the switch including a plurality of ports and a table, the plurality of ports having a dummy port, which has an available port number allowing hardware-access, discards packets switched to the dummy port, and exists as a logical number, the table storing addresses corresponding to network addresses of hosts and information about corresponding connection ports; and
a controller to, when the address corresponding to destination address of the packet trapped by the switch chip does not exist, determine the nonexistence of the address, virtually set the address corresponding to the destination network address, and update the table of the switch as if the host of the set virtual address were connected to the dummy port.

2. The apparatus of claim 1, wherein, the network is an Internet Protocol (IP) network, the switch is an Ethernet switch chip, and the table is a layer 3 table, and the addresses are Media Access Control (MAC) addresses.

3. The apparatus of claim 2, wherein, in identifying the nonexistence of the MAC address, both the MAC address corresponding to the actual IP address of the destination of the corresponding trapped packet and a corresponding connection port are identified through transmission of “Neighbor Solicitation” message and reception of the response for the transmission of the “Neighbor Solicitation” message.

4. A packet switching method of the packet switching apparatus applied to a network, the packet switching apparatus comprising a switch to perform packet switching, which comprises a table storing address corresponding to the network address of the hosts and information about the corresponding connection port and performs the packet switching operation, the method comprising the steps of:
virtually setting, when information about address corresponding to the network address of the destination host of the packet transmitted from a certain host is not prestored, the address corresponding to the destination network address, and updating the table of the switch as if the host of the set virtual address were connected to the preset virtual dummy port; and
updating the table of the switch by transmitting a “Neighbor Solicitation” message and receiving a response to the “Neighbor Solicitation” message in order to identify the address corresponding to the actual network address of the corresponding destination.

5. The apparatus of claim 1, wherein, the network is an Internet Protocol (IP) network, the switch is an Ethernet switch chip, and the table is a layer 3 table, and the addresses are Media Access Control (MAC) addresses.

6. The method of claim 5, wherein the transmission of the “Neighbor Solicitation” message and reception of the response to the “Neighbor Solicitation” message are repeatedly executed up to the predetermined number of times.

7. The method of claim 6, wherein, when the response is not received while repeatedly executing the transmission and reception of message up to the predetermined number of times, the corresponding packet information stored in the layer 3 table of the Ethernet switch chip is deleted.
